(19) United States
(12) Patent Application Publication
(10) Pub. No.: US 2008/0086798 A1
(43) Pub. Date: Apr. 17, 2008

(54) Simulated rip stop fabrics

(75) Inventors: Michael Bruce Allen II, Newnan, GA (US); Mike Creech, Newnan, GA (US)

Correspondence Address: JOHN S. PRATT, ESQ;KILPATRICK STOCKTON, LLP, 1100 PEACHTREE STREET, ATLANTA, GA, 30309, US

(73) Assignee: Southern Mills, Inc., Union City, GA (US)

(21) Appl. No.: 11/982,749

(22) Filed: Nov. 5, 2007

Related U.S. Application Data
(63) Continuation of application No. 10/974,898, filed on Oct. 27, 2004, now abandoned.

(51) Int. Cl. A62B 17/00; A41D 1/06; A41D 13/02; B32B 5/02; A41D 3/02

(52) U.S. Cl. 2/458; 2/79; 2/85; 2/93; 428/219; 428/221

(57) ABSTRACT

Disclosed are simulated rip stop fabrics. In one embodiment, a simulated rip stop fabric includes a plurality of body yarns that form a body of the fabric, and a plurality of pseudo rip stop yarns that are provided individually in discrete portions of the fabric body so as to form a grid pattern, the psuedo rip stop yarns comprising at least three individual yarns that are plied together.

### BACKGROUND

Firefighters typically wear protective garments commonly referred to in the industry as turnout gear. Turnout gear normally comprises various garments including, for instance, coveralls, trousers, and jackets. These garments usually include several layers of material including, for example, an outer shell that protects the wearer from flames, a moisture barrier that prevents the ingress of water into the garment, and a thermal barrier that insulates the wearer from extreme heat.

In addition to shielding the wearer from flames, the outer shells of firefighter turnout gear further provide protection from sharp objects. In that the outer shell must withstand exposure to flame and excessive heat and must be resistant to tearing, it must be constructed of a flame resistant material that is both strong and durable.

One common method for increasing the strength or tear resistance of a fabric, including outer shell fabrics, is to form what is called a rip stop weave. A rip stop weave is a weave that includes a grid of multiple ends and picks that are woven side-by-side along the fabric to reduce the propagation of tears and, therefore, increase the fabric strength. Common rip stop weaves include two-end and three-end rip stop weaves in which two or three ends/picks, respectively, are woven along with each other intermittently throughout the fabric.

Although the provision of such rips increases the strength of the fabric, the rips can adversely affect the appearance of the fabric. For example, the rips can be higher tensioned during the weaving processes relative to the other yarns of the fabric, resulting in undesired puckering. Furthermore, the fibers of the rips can “fibrillate” at the cross-over points, i.e., the points in the fabric at which the rips of one direction of the fabric cross over the rips of the other direction of the fabric. Such fibrillation results in small fibrils being formed that extend from the shafts of the fibers in the rips. Those fibrils can create a frosted appearance for the fabric along the rip stop grid and, therefore, a non-uniform color across the fabric.

In view of the above, it would be desirable to be able to produce outer shell fabrics, and other fabrics, that are highly tear resistant, but which are not rip stop fabrics.

### SUMMARY

Disclosed are simulated rip stop fabrics. In one embodiment, a simulated rip stop fabric includes a plurality of body yarns that form a body of the fabric, and a plurality of pseudo rip stop yarns that are provided individually in discrete portions of the fabric body so as to form a grid pattern, the psuedo rip stop yarns comprising at least three individual yarns that are plied together.

### BRIEF DESCRIPTION OF THE DRAWINGS

The disclosed fabrics can be better understood with reference to the following drawings. The components in the drawings are not necessarily to scale.

FIG. 1 is a rear view of an example protective garment that includes a simulated rip stop fabric.

FIG. 2 is a schematic representation of a simulated rip stop fabric that can be used in the construction of the garment of FIG. 1.

FIG. 3 is a schematic representation of a body yarn that can be used to construct the fabric of FIG. 2.

FIG. 4 is a schematic representation of a first embodiment of a pseudo rip stop yarn that can be used to construct the fabric of FIG. 2.

FIG. 5 is a schematic representation of a second embodiment of a pseudo rip stop yarn that can be used to construct the fabric of FIG. 2.

### DETAILED DESCRIPTION

As is described in the foregoing, it would be desirable to be able to provide fabrics that are highly resistant to tearing, but that are not rip stop fabrics. As is described in the following, such a result can be achieved by substituting individual pseudo-rip stop yarns for the multiple rip stop yarns (or “rips”) that are provided in typical rip stop weaves. Through such substitution, problems that may be encountered with rip stop weaves, such as puckering and color non-uniformity, can be reduced or avoided completely. As is described in greater detail below, the pseudo rip stop yarn can comprise a plied yarn having from 3 to 7 single yarns that are twisted together.

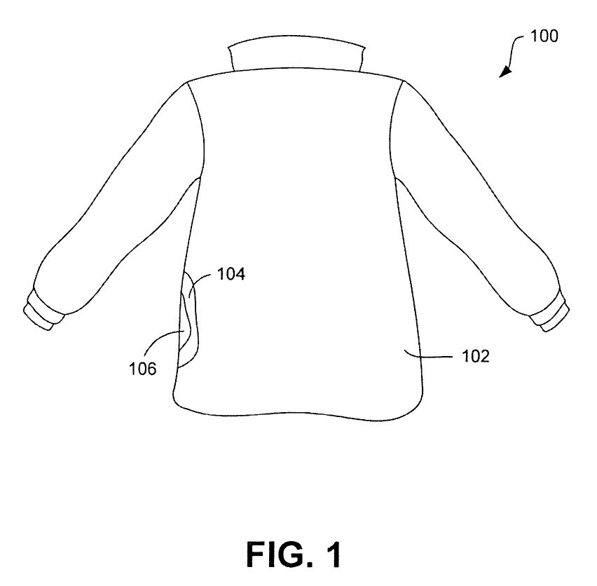

FIG. 1 illustrates an example protective garment 100. More particularly, FIG. 1 illustrates a firefighter turnout coat that can be donned by firefighter personnel when exposed to flames and extreme heat. It is noted that, although a firefighter turnout coat is shown in the figure and is described herein, embodiments of this disclosure pertain to garments and fabrics generally. Accordingly, the identification of firefighter turnout gear is not intended to limit the scope of the disclosure.

As is indicated in FIG. 1, the garment 100 generally comprises an outer shell 102 that forms the exterior surface of the garment, a moisture barrier 104 that forms an intermediate layer of the garment, and a thermal liner 106 that forms the interior surface (i.e., the surface that contacts the wearer) of the garment. In that it forms the exterior surface of the garment 100, the outer shell 102 preferably is constructed so as to be flame resistant to protect the wearer against being burned. In addition, the outer shell 102 preferably is strong and durable so as to be resistant to abrasion and tearing during use in hazardous environments.

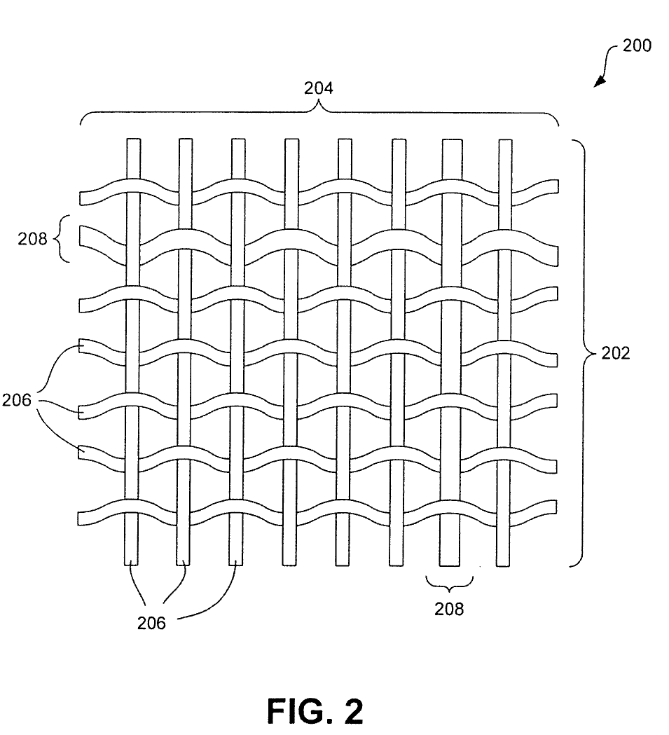

FIG. 2 is a schematic detail view of an example blended outer shell fabric 200 that can be used in the construction of the protective garment 100, and more particularly the outer shell 102 shown in FIG. 1. It is noted, however, that the fabric 200 could be used in the construction of other garments, either by itself or in combination with other fabrics. The example fabric 200 illustrated in FIG. 2 is a plain weave fabric that simulates rip stop fabrics. Accordingly, the fabric 200 may be referred to as a simulated rip stop fabric.

The fabric 200 comprises a plurality of body yarns 206, including picks 202 and ends 204, and a plurality of pseudo rip stop yarns 208. In some embodiments, the fabric 200 comprises a blend of inherently flame resistant materials. This blend can comprise a single type of inherently flame resistant fibers, or a blend of two or more different types of inherently flame resistant fibers. By way of example, the yarns of the fabric 200, including one or more of the picks 202, ends 204, and pseudo rip stop yarns 208, comprise a blend of para-aramid fibers and meta-aramid fibers. Example blends of those materials include blends that comprise about 40% to about 60% para-aramid, and about 40% to about 60% meta-aramid. For instance, one preferred embodiment comprises a 50/50 blend of para-aramid and meta-aramid fibers.

Example para-aramid fibers include those that are currently available under the trademarks KEVLAR® (DuPont) and TECHNORA® and TWARON® (Teijin). Example meta-aramid fibers include those sold under the tradenames NOMEX T-450® (100% meta-aramid), NOMEX T-455® (a blend of 95% NOMEX® and 5% KEVLAR®), and NOMEX T-462® (a blend of 93% NOMEX®, 5% KEVLAR®, and 2% anti-static carbon/nylon), each of which is produced by DuPont. Example meta-aramid fibers also include fibers that are currently available under the trademark CONEX®, which is produced by Teijin.

It is noted that, for purposes of the present disclosure, when a material name is used herein, the material referred to, although primarily comprising the named material, may not be limited to only the named material. For instance, the term “meta-aramid fibers” is intended to include NOMEX® T-462 fibers, which, as is noted above, comprise relatively small amounts of para-aramid fiber and anti-static fiber in addition to fibers composed of meta-aramid material.

While para-aramid and meta-aramid fibers have been explicitly identified above, other inherently flame resistant fibers may be used to construct the fabric, including, for example, polybenzoxazole (PBO), polybenzimidazole (PBI), melamine, polyamide, polyimide, polyimideamide, and modacrylic.

Notably, materials that are not inherently flame resistant can also be used to construct the fabric 200, if desired. For instance, the fabric 200 may comprise fibers that are made of material that, although not naturally flame resistant, can be made flame resistant through application or addition of a suitable flame retardant. Examples of such materials include flame resistant cellulosic materials, such as FR rayon, FR acetate, FR triacetate, and FR lyocell. Moreover, in cases in which flame resistance is not needed, non-flame resistant fibers may be used to construct the fabric 200.

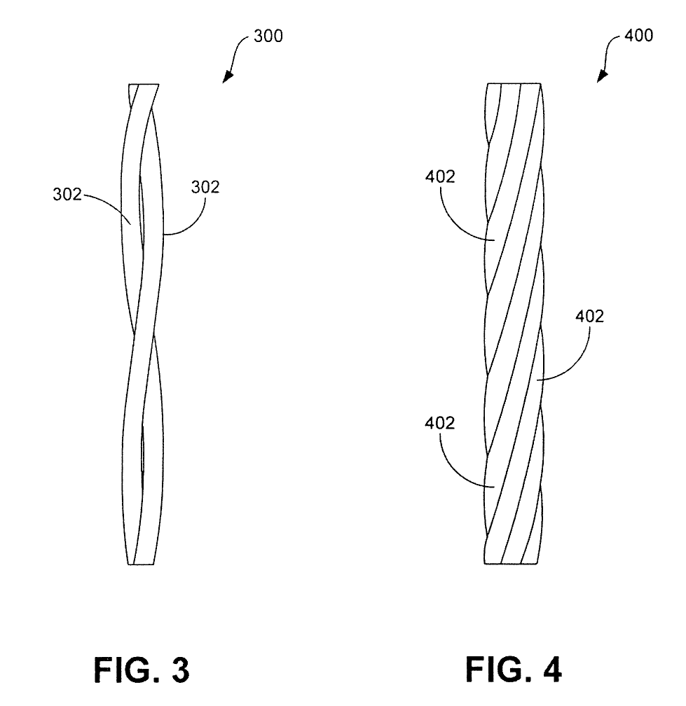

The body yarns 206 typically comprise spun yarns that, for example, each comprise a single yarn or two or more individual yarns that are plied, twisted, or otherwise combined together. By way of example, the body yarns 206 comprise one or more yarns that each have a yarn count (or “cotton count”) in the range of approximately 10 to 40 cc. In some embodiments, the body yarns 206 can comprise two yarns that are twisted together, each having a yarn count in the range of approximately 10 to 25 cc. In one preferred embodiment, each body yarn 206 comprises two yarns, each having a yarn count of 21 cc (i.e., a 21/2 yarn). FIG. 3 illustrates an example embodiment 300 for a body yarn 206. As is indicated in that figure, the body yarn embodiment 300 includes two individual yarns 302 that are twisted together.

The pseudo rip stop yarns 208 can comprise spun yarns that are similar to the body yarns 206, but are larger in terms of yarn count and/or diameter. The pseudo rip stop yarns 208 comprise plied yarns that include at least three individual yarns that are combined together. An example embodiment 400 for the pseudo rip stop yarns 208 is illustrated in FIG. 4. As is apparent from FIG. 4, the pseudo rip stop yarn embodiment 400 includes a plurality of individual yarns 402 that are twisted together. The degree of twist can be varied to suit the application. In some embodiments, the pseudo rip stop yarn 208 has a twist multiple of about 2 to about 5. By way of example, each of the individual yarns 402 has a yarn count of about 10 to about 40 cc, and 3 to 7 such yarns are twisted together to form the plied yarn. In such a case, the pseudo rip stop yarns 208 have a yarn count from about 2 cc to about 6 cc. In one preferred embodiment, each pseudo rip stop yarn 208 comprises 4 or 5 yarns each having a cotton count of 21 (i.e., a 21/4 or 21/5 yarn).

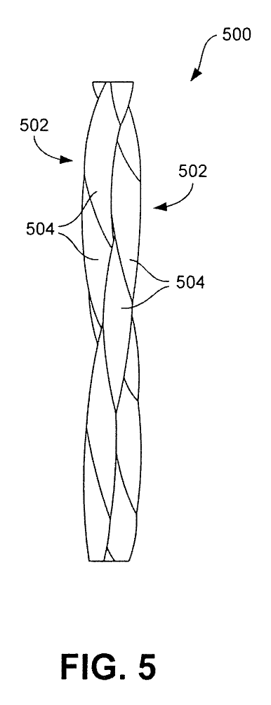

It is noted that alternative constructions are possible for the pseudo rip stop yarns 208. For instance, the pseudo rip stop yarns 208 can comprise cabled yarns. Such cabled yarns comprise two or more plied yarns (i.e., yarns that incorporate two or more individual yarns) that are plied together to form a cable. For instance, two 21/2 plied yarns could be plied together to form a pseudo rip stop yarn 208. An embodiment 500 of such a cabled yarn is shown in FIG. 5. As is indicated in that figure, the cabled yarn embodiment 500 comprises two plied yarns 502 that are plied together. In the example of FIG. 5, each plied yarn 502 comprises two individual yarns 504.

The placement of the pseudo rip stop yarns 208 within the fabric 200 can be varied depending upon the desired physical properties. In the embodiment shown in FIG. 2, the pseudo rip stop yarns 208 are provided within the fabric 200 in a grid pattern in which several body yarns 206 are placed between each consecutive pseudo rip stop yarn 208 in both the warp and filling directions of the fabric. By way of example, a single pseudo rip stop yarn 208 is provided in the fabric 200 in both the warp and filling directions of the fabric for every about 7 to about 14 body yarns 206. In some embodiments, the grid pattern forms a plurality of squares. To accomplish this, a greater number of body yarns 206 may need to be provided between consecutive pseudo rip stop yarns 208 in the one direction as compared to the other direction.

With the constructions described above, the fabric 200 has a weight of about 5 to about 9 ounces per square yard (osy). In one preferred embodiment, the fabric 200 has a weight of about 7.5 osy.

The fabric 200 can be colored to suit the application. Such coloring can be achieved in various ways. In some embodiments, the fibers that are used to construct the fabric 200 are producer colored. Producer coloring, which is also referred to as solution dyeing, is a method in which color pigment is added to the solution from which the fibers are spun. One advantage of producer coloring is that the entirety of the fibers, both inside and out, are colored. This can result in deeper, more colorfast fabric shades.

In other embodiments, the fibers, yarns, or fabric 200 can be dyed using any one of various dyeing methods. By way of example, the fabric 200 can be piece dyed using an exhaust process, such as jet dyeing.

### EXAMPLE FABRIC

A pre-blend of black, producer-colored N310 from DuPont, which comprises a 50/50 blend of KEVLAR® (para-aramid) and NOMEX® (meta-aramid), was constructed having a fabric weight of approximately 7.5 osy. The fabric was formed as a plain weave fabric (see, e.g., FIG. 2) having 56 ends per inch and 41 picks per inch, with 9 ends provided between each pseudo rip stop yarn in the warp direction, and 9 picks provided between each pseudo rip stop yarn in the filling direction. The body yarns of the fabric comprised two 50/50 KEVLAR®/NOMEX® yarns each having a yarn count of 21 cc (i.e., 21/2 yarns), while the pseudo rip stop yarns comprised five 50/50 KEVLAR®/NOMEX® yarns each having a yarn count of 21 cc (i.e., a 21/5 yarn).

The example fabric was evaluated in terms of aesthetic appearance, and was compared to a black, producer-colored 50/50 KEVLAR®/NOMEX® three-end rip stop fabric. This comparison revealed that the example fabric (i.e., the simulated rip stop) exhibited significantly less puckering and greater color uniformity as compared to the rip stop fabric. Although the reasons for this improvement have not been scientifically verified, it appears that use of the pseudo rip stop yarns of the simulated rip stop fabric reduces puckering because the pseudo rip stop yarns are smaller than the bundled sets of picks and ends that form the rips of the rip stop fabric and, therefore, are less disruptive to the fabric. In addition, the pseudo rip stop yarns are tensioned more uniformly relative to the remainder of the fabric during weaving as compared to rips of rip stop weaves due to the repetitive nature of the plain weaving process. In contrast, rip stop weaving processes comprise periodic pauses or hesitations that cause greater variation in tension between the rips and the remainder of the fabric.

The pseudo rip stop yarns are further believed to improve color uniformity because, given that the pseudo rip stop yarns are smaller than the bundled rips of the rip stop fabric, less damage is caused to the fibers of pseudo rip stop yarns at the cross-over points, thereby resulting in less fibrillation and the non-uniformity that such fibritation causes.

While particular embodiments of fabrics have been disclosed in detail in the foregoing description and drawings for purposes of example, it will be understood by those skilled in the art that variations and modifications thereof can be made without departing from the scope of the disclosure.

We claim:

1. A simulated rip stop fabric, comprising:
a plurality of body yarns, wherein each of the body yarns comprises at least one component yarn; and
a plurality of pseudo rip stop yarns, wherein each of the pseudo rip stop yarns comprises at least two component yarns,
wherein each component yarn in the fabric comprises the same blend of a plurality of types of fibers, wherein the percentage of each type of fiber in each component yarn is substantially the same as the percentage of that type of fiber in each other component yarn.

2. The fabric of claim 1, wherein the body yarns comprise two component yarns that are plied together.

3. The fabric of claim 1, wherein the component yarns comprise para-aramid and meta-aramid fibers.

4. The fabric of claim 3, wherein the component yarns comprise from about 40% to about 60% para-aramid fibers and from about 40% to about 60% meta-aramid fibers.

5. The fabric of claim 4, wherein the component yarns comprise about 50% para-aramid fibers and 50% meta-aramid fibers.

6. The fabric of claim 1, wherein a yarn count is associated with each component yarn and is the same for every component yarn.

7. The fabric of claim 1, wherein comprise polybenzoxazole (PBO) fibers.

8. The fabric of claim 1, wherein the component comprise polybenzimidazole (PBI) fibers.

9. The fabric of claim 1, wherein the pseudo rip stop yarns comprise 3 to 7 component yarns that are plied together.

10. The fabric of claim 9, wherein the pseudo rip stop yarns comprise 4 component yarns that are plied together.

11. The fabric of claim 9, wherein the pseudo rip stop yarns comprise 5 component yarns that are plied together.

12. The fabric of claim 1, wherein the pseudo rip stop yarns have a yarn count from about 2 cc to about 6 cc, inclusive.

13. The fabric of claim 1, wherein the pseudo rip stop yarns comprise cabled yarns.

14. The fabric of claim 1, wherein the fabric comprises a single pseudo rip stop yarn every about 7 to about 14 body yarns in both directions of the fabric.

15. The fabric of claim 1, wherein the fabric has a weight of about 5 ounces per square yard (osy) to about 9 osy.

16. The fabric of claim 1, wherein at least some of the fibers of the fabric are producer colored.

17. A simulated rip stop fabric comprising a plurality of yarns consisting of:
a. a plurality of body yarns, wherein each of the body yarns comprises at least one component yarn; and
b. a plurality of pseudo rip stop yarns, wherein each of the pseudo rip stop yarns comprises at least two component yarns,
wherein each component yarn in the fabric comprises the same blend of a plurality of types of fibers, wherein the percentage of each type of fiber in each component yarn is substantially the same as the percentage of that type of fiber in each other component yarn.

18. The fabric of claim 17, wherein the body yarns comprise two component yarns that are plied together.

19. The fabric of claim 17, wherein the fibers comprise para-aramid fibers and meta-aramid fibers.

20. The fabric of claim 19, wherein the component yarns comprise from about 40% to about 60% para-aramid fibers and from about 40% to about 60% meta-aramid fibers.

21. The fabric of claim 17, wherein the component yarns comprise at least one of polybenzoxazole (PBO) or polybenzimidazole (PBI) fibers.

22. The fabric of claim 17, wherein the pseudo rip stop yarns comprise 4 component yarns that are plied together.

23. The fabric of claim 17, wherein the pseudo rip stop yarns comprise 5 component yarns that are plied together.

24. The fabric of claim 17, wherein the pseudo rip stop yarns comprise cabled yarns.

25. The fabric of claim 17, wherein the fabric has a weight of about 6 ounces per square yard (osy) to about 14 osy.

26. The fabric of claim 17, wherein at least some of the fibers are producer colored.

27. A firefighter turnout garment, comprising:
a thermal liner that forms an interior surface of the garment;
a moisture barrier that forms an intermediate layer of the garment; and
an outer shell that forms an exterior surface of the garment, the outer shell comprising:
a plurality of body yarns, wherein each of the body yarns comprises at least one component yarn; and
a plurality of pseudo rip stop yarns, wherein each of the pseudo rip stop yarns comprises at least two component yarns,
wherein each component yarn in the fabric comprises the same blend of a plurality of types of fibers, wherein the percentage of each type of fiber in each component yarn is substantially the same as the percentage of that type of fiber in each other component yarn.

28. The garment of claim 27, wherein the component yarns comprise from about 40% to about 60% para-aramid fibers and from about 40% to about 60% meta-aramid fibers.

29. The garment of claim 27, wherein the component yarns comprise at least one of polybenzoxazole (PBO) or polybenzimidazole (PBI) fibers.

30. The garment of claim 27, wherein the pseudo rip stop yarns comprise 3 to 7 component yarns that are plied together.

31. The garment of claim 27, wherein the pseudo rip stop yarns have a yarn count of about 2 cc to about 6 cc, inclusive.

32. The garment of claim 27, wherein the pseudo rip stop yarns comprise cabled yarns.

33. The garment of claim 27, wherein the outer shell comprises a single pseudo rip stop yarn every about 7 to about 14 body yarns in both directions of the garment.

34. The garment of claim 27, wherein the outer shell has a weight of about 5 ounces per square yard (osy) to about 9 osy.

35. The garment of claim 27, wherein at least some of the fibers of the outer shell are producer colored.

36. The garment of claim 27, wherein the garment is at least one of a jacket, trousers, or coveralls.

37. The fabric of claim 1, wherein each body yarn comprises two component yarns and each pseudo rip stop yarn comprises five component yarns, wherein each component yarn comprises approximately 50% para-aramid fibers and about 50% meta-aramid fibers.

38. The fabric of claim 37, wherein each component yarn has a yarn count of approximately 21 cc.

39. The fabric of claim 17, wherein each body yarn comprises two component yarns and each pseudo rip stop yarn comprises five component yarns, wherein each component yarn comprises approximately 50% para-aramid fibers and about 50% meta-aramid fibers.

40. The fabric of claim 39, wherein each component yarn has a yarn count of 21 cc.

41. The garment of claim 27, wherein each body yarn comprises two component yarns and each pseudo rip stop yarn comprises five component yarns, wherein each component yarn comprises approximately 50% para-aramid fibers and about 50% meta-aramid fibers.

42. The garment of claim 41, wherein each component yarn has a yarn count of 21 cc.

43. A simulated rip stop fabric comprising:
a plurality of body yarns, wherein each of the body yarns consists of at least one component yarn; and
a plurality of pseudo rip stop yarns, wherein each of the pseudo rip stop yarns consists of at least two component yarns,
wherein each component yarn in the fabric comprises the same blend of a plurality of types of fibers, wherein the percentage of each type of fiber in each component yarn is substantially the same as the percentage of that type of fiber in each other component yarn.
